(19) United States
(12) Patent Application Publication
(10) Pub. No.: US 2011/0193988 A1
(43) Pub. Date: Aug. 11, 2011

(54) SEMICONDUCTOR DEVICE AND SEMICONDUCTOR INTEGRATED CIRCUIT

(75) Inventor: Toshinobu HATANO, Kyoto (JP)

(73) Assignee: PANASONIC CORPORATION, Osaka (JP)

(21) Appl. No.: 13/086,494

(22) Filed: Apr. 14, 2011

Related U.S. Application Data
(63) Continuation of application No. PCT/JP2009/001796, filed on Apr. 20, 2009.

(30) Foreign Application Priority Data
Oct. 15, 2008 (JP) 2008-266164

(51) Int. Cl. G06F 12/00; G06F 15/80; H04N 5/228

(52) U.S. Cl. 348/222.1; 711/154; 345/505; 711/E12.001; 348/E05.031

(57) ABSTRACT

The semiconductor device having task processing units which perform predetermined functional processes and are capable of freely accessing memories independently of each other, includes: the task processing units provided on the semiconductor substrate and configured to select at least one of the memories independently of each other and issue requests for memory access to the selected memory; and memory control units which are capable of operating independently of each other, correspond to the respective memories independently of each other, and are each configured to arbitrate the requests for memory access from the task processing units and connect, to the respective memories, the task processing units which have issued the arbitrated requests for memory access so that data can be transferred between the task processing units and the memories.

### CROSS REFERENCE TO RELATED APPLICATIONS

This is a continuation application of PCT application No. PCT/JP2009/001796 filed on Apr. 20, 2009, designating the United States of America.

### BACKGROUND OF THE INVENTION

(1) Field of the Invention

The present invention relates to semiconductor devices and semiconductor integrated circuits, and particularly to a semiconductor device and a semiconductor integrated circuit which perform plural processes in parallel while transferring data to and from memory units.

(2) Description of the Related Art

In recent years, unique digital cameras have been commercialized which provide a standard function such as a function of high-speed continuous shooting at a super-high resolution or a function of high-speed shooting at more than 60 frames per second and a function of super-slow-motion replay. These functions are achieved using a super-high speed output sensor and a dedicated image processing large scale integration (LSI). In order to achieve such new high-speed functions including the high-speed shooting, it is necessary to greatly increase bus transmission capacity for memory access in image processing and data processing and to increase flexibility of memory access for handling of multiple tasks. In other words, there is a need for image processing to increase overall efficiency of processing for input and output devices so that a fast application can be executed.

In a present mainstream method, a single dedicated image processing LSI which performs such new high-speed functions executes multiple processes in parallel (multitasking) with memory accesses while arbitrating requests for access to a memory (also referred to as memory access requests). Bus transmission capacity for memory access is increased generally by increasing clock speed of memory access or by expanding data bus width.

In a semiconductor integrated circuit for image processing, there is a demand for development of elemental technologies usable at high speed, low voltage, and low power consumption, in addition to a demand for finer process rules. Furthermore, increase in the number of input and output units is expected for addition of such new functions. Because of this, a technique to pack a multi-pin semiconductor integrated circuit in a small area in a layout outside a peripheral area of a chip, and a technique to pack multiple chips in a single package are important for providing a semiconductor integrated circuit with necessary input and output units.

In a conventional general image recording and reproducing apparatus, in order to record a captured image and reproduce the recorded image, analog-digital converted image data is subjected to pre-processing, image signal processing, displaying, and recording in a medium are performed as basic task processes through a memory control unit. The task processes are performed by accessing an image memory in which image data being processed is temporarily stored through a memory control unit according to a command from a central processing unit (CPU). Here, the task processes are performed apparently in parallel, which is what is called multitasking.

When different tasks seek access to a common input and output device (for example, a memory control unit) by multitasking, the memory is accessed by one of the tasks which is first to access the memory control unit among the tasks, and the memory is occupied by the task until the task is finished. It is not until the memory access by the foregoing task is finished and traffic of memory access becomes unoccupied that the subsequent tasks which are second or later to seek access to the input and output device access the memory.

In such a method of accessing an input and output device, when a task is accessing the input and output device, any other highly-urgent tasks requesting access to the input and output device are required to wait until the access to the input and output device by the foregoing task ends. This has caused a problem that even an urgent task (for example, a process prioritized by a user) is kept waiting for memory access.

As an approach to the problem, a technique is presented in Japanese Unexamined Patent Application Publication Number 10-283204 (Patent Reference 1) in which a sleep is put in a task of low priority and a task in its sleep is skipped or its time for accessing a common device is shortened when its turn to be processed comes. This allows a process for an urgent task to be preferentially performed using a common device.

Japanese Unexamined Patent Application Publication Number 2006-87069 (Patent Reference 2) discloses a technique in which a unit of processing of a large data amount is set for a task of higher priority, a unit of processing of a small data amount is set for a task of lower priority, and the plurality of tasks are switched after processing of each unit of processing.

FIG. 7 is a block diagram showing a configuration of an image processing apparatus 400 disclosed in Patent Reference 2. In the image processing apparatus 400 shown in FIG. 7, a memory 401 temporarily stores image data output from an A/D converter 403 to write onto a recording medium 404. The memory 401 also temporarily stores image data read from the recording medium 404 to display the image data on an image display unit 405.

In the image processing apparatus 400 shown in FIG. 7, a multitasking performed in which, for example, image data from the memory 401 is written onto the recording medium 404 (writing process) and image data on the recording medium 404 is read out to the memory 401 (reading process). The memory control unit 402 determines the priority for each of the processes, sets a unit of processing for each of the processes depending on the priority, and performs each of the processes by the unit of processing. With this, a process of high priority is preferentially performed and overall efficiency in the processing is increased.

Non-patent Reference 1 (NIKKEI ELECTRONICS, Apr. 21, 2008, pp. 12 to 13) discloses a technique in which new high-speed functions are executed not by a single dedicated image processing LSI and multiple tasks are distributed to two or more dedicated image processing LSIs. In this technique, pre-processing and post-processing of image processing are distributed between two dedicated image processing LSIs, and a dedicated large-volume dynamic random access memory (DRAM) is provided so that a fast application can be executed.

As described above, in the Patent Reference 1 and Patent Reference 2, overall efficiency in processing by the memory control unit is increased by arbitrating requests for memory access according to priority. In the technique disclosed in Non-patent reference 1, processes are distributed among two or more dedicated image processing LSIs, and thus efficiency in processing is increased.

However, these conventional techniques have the problems below.

In the techniques disclosed in Patent Reference 1 and Patent Reference 2, absolute bus transmission capacity for memory access is insufficient for processing larger data at high speed.

Specifically, Patent Reference 1 discloses a method of efficient use of limited bus transmission capacity for memory access. In this method, one access time and a sleep time are determined on the basis of priority. Under such control, all of the tasks may be in sleep when requests for access to a common device are made by none of the tasks of higher priority but only by tasks of lower priority. In this case, no task accesses the common device, so that processing is inefficient.

In other cases, even when processes are performed with high efficiency due to an access time and a sleep time between tasks at a time, the access time and the sleep time remain unchanged even after one of the tasks are completed, for example. Because of this, processing is inefficient especially when a task of high priority is completed and all the tasks being processed have lower priority and in sleep.

In other cases, when multiple tasks are accessing a common device and a task of lower priority additionally occurs, there is no time during which all of the tasks of lower priority are in sleep, and all the tasks are therefore processed for access times preset for respective tasks simply in turns. As a result, processing a task of higher priority takes a long time.

Some of such problems with the technique disclosed in Patent Reference 1 are solved by the technique disclosed in Patent Reference 2, in which units of processing of data amounts different according to priority are set for respective tasks, and the tasks are processed in parallel while being switched. However, as with the technique disclosed in Patent Reference 1, the technique disclosed in Patent Reference 2 increases efficiency in processing by a memory control unit but does not solve a shortage of absolute bus transmission capacity for memory access.

Here, the technique disclosed in Patent Reference 1 or Patent Reference 2 may increase efficiency in processing by a memory control unit but fails to eliminate a shortage of absolute bus transmission capacity for memory access. Therefore, processing cannot be performed at a required speed when it is necessary to process mass data, such as image data obtained by high-speed continuous shooting of high resolution images.

The techniques for efficient use of bus transmission capacity shown in Patent Reference 1 and Patent Reference 2 surely produce advantageous effects in the case where the number of pixels of a sensor is no more than a given number. However, it is now necessary to respond to a demand for a new high-speed function such as high-speed shooting using a super high resolution sensor. In order to meet the demand, increasing efficiency in processing of a memory control unit as shown in Patent Reference 1 and Patent Reference 2 is not sufficient because larger absolute bus transmission capacity for memory access is necessary for image processing and data processing.

In the technique disclosed in Non-patent Reference 1, multiple tasks are distributed among two or more dedicated image processing LSIs and processed using a dedicated large-volume DRAM. However, the technique may involve mass data transfer between the LSIs or redundancy between the functions of the LSIs, therefore the technique is not optimal in view of power consumption, costs, and mounting area, with room for improvement in many aspects.

The present invention, conceived to address the problems, has an object of providing a semiconductor device and an integrated circuit having greatly increased bus transmission capacity for memory access and increased flexibility in memory access for multitasking, and thereby increasing overall efficiency of processing for input and output devices.

### SUMMARY OF THE INVENTION

In order to solve the problems above, the semiconductor device including task processing units which perform predetermined functional processes and are capable of accessing memories independently of each other, according to an aspect of the present invention includes: a semiconductor substrate; the task processing units formed on the semiconductor substrate and configured to select at least one of the memories independently of each other and issue requests for memory access to the selected memory independently of each other; and memory control units which are capable of operating independently of each other, are formed on the semiconductor substrate, correspond to the respective memories independently of each other, and are each configured to arbitrate the requests for memory access from the task processing units and connect, to the respective memories, the task processing units which have issued the arbitrated requests for memory access so that data can be transferred between the task processing units and the memories.

In this configuration, the plurality of memory control units significantly increases bus transmission capacity between the task processing units and the memories. In addition, each of the task processing units independently accesses to the plurality of memories through the plurality of memory control units. In other words, the task processing units is allowed to select a memory control unit to connect as necessary. Flexibility in memory access is thereby increased.

Furthermore, each of the task processing units may include at least one of: an image processing unit configured to process a first image data externally input or a second image data stored in at least one of the memories; a compression-expansion processing unit configured to change a size of the first image data, the second image data, or image data processed by the image processing unit; a display processing unit configured to perform processing for causing a display unit to display the first image data, the second image data, or the image data processed by the image processing unit or the compression-expansion processing unit; and a processor unit configured to control at least one of the image processing units, the compression-expansion processing unit, and the display processing unit.

In this configuration, image processing is accelerated to meet the requirement of high-speed mass data processing.

Furthermore, the semiconductor device may further include a multiport interface unit which is formed on the semiconductor substrate and configured to selectively connect each of the task processing units and each of the memory control units.

In this configuration, connections between the task processing units and the memory control unit may be easily changed.

Furthermore, the multiport interface unit may have an output terminal for each of the task processing units, an input terminal for each of the task processing units, an output terminal for each of the memory control units, and an input terminal for each of the memory control units.

Furthermore, when the multiport interface unit connects one of the task processing units and one of the memory control units, the multiport interface unit may be configured to transfer input data received from the connected task processing unit to the connected memory control unit.

Furthermore, when the multiport interface unit connects one of the task processing units and two or more of the memory control units, the multiport interface unit may be configured to transfer input data received from the connected task processing unit to the connected two or more memory control units in parallel.

Furthermore, when the multiport interface unit connects one of the memory control units and one of the task processing units, the multiport interface unit may be configured to transfer input data received from the connected memory control unit to the connected task processing unit.

Furthermore, when the task processing units simultaneously process time-sensitive processes, the task processing units may be configured to transfer data, via a memory control unit predetermined for each of the task processing units, to and from the memory corresponding to the memory control unit.

In this configuration, each of the task processing units is provided with a predetermined memory control unit to connect to, so that separation and distribution of traffic of memory access can be easily managed when time-sensitive tasks are simultaneously operated.

Furthermore, when the task processing units simultaneously process time-sensitive processes, the task processing units may be configured to select a source memory and a destination memory for data of each of the processes from among the memories, depending on a type of the process to be performed by each of the task processing units.

In this configuration, a memory is selected depending on the process to be performed, so that separation and distribution of traffic of memory access can be easily managed when time-sensitive tasks are simultaneously operated. For example, a memory to connect to is selected in a manner such that a task processing unit which performs image data processing is connected to a first memory, and a task processing unit which performs resizing of images is connected to a second memory.

Furthermore, when the task processing units simultaneously process time-sensitive processes, each of the task processing units may be configured to monitor a status of memory access from the memory control units, select, from among the memory control units, a memory control unit having an idle rate of memory access larger than a predetermined threshold, and transfer data, via the selected memory control unit, to and from the memory corresponding to the selected memory control unit.

In this configuration, a memory control unit is selected depending on the statuses of memory access, so that separation and distribution of traffic of memory access can be easily managed when time-sensitive tasks are simultaneously operated. For example, a memory control unit to connect to is selected depending on an idle rate of memory access in a manner such that a task processing unit is connected to a first memory control unit when the first memory control unit has an idle rate larger than a threshold, and to a second memory control unit when the first memory control unit has an idle rate smaller than the threshold.

Furthermore, when the task processing units simultaneously process time-sensitive processes and memory access processing is smaller than a predetermined threshold, the task processing units may be configured to select a common one of the memory control units and transfer data, via the selected memory control unit, to and from the memory corresponding to the selected memory control unit, and place, into sleep mode, the memory control unit other than the memory control unit selected by the task processing units.

In this configuration, small access processing is concentrated on one memory control unit, and the other memory control unit is placed into sleep mode, and thus saving power.

Furthermore, when the task processing units simultaneously process time-sensitive processes, the task processing units may be configured to transfer data, via one of the memory control units, to and from the memory corresponding to the memory control unit, and transfer data, via an other one of the memory control units, to and from the memory corresponding to the other one.

In this configuration, a task processing unit is allowed to access another memory via another memory control unit as necessary, thus extending operation of the system.

Furthermore, when a task to be performed by one of the task processing units is prior to a task to be performed by an other one of the task processing units, the one of the task processing units may be configured to exclusively use one of the memory control units and transfer data, via the exclusively used memory control unit, to and from the memory corresponding to the exclusively used memory control unit.

In this configuration, when a process to be performed by one task processing unit is prior to a process to be performed by the other task processing unit, the one task processing unit exclusively uses one of the memory control units. The one task processing unit therefore does not need to perform arbitration due to interruption from other processing units so that the process can be performed at high speed. This configuration produces an advantageous effect particularly for a system provided with a plurality of CPUs for use in, for example, network protocol processing or software graphic processing.

Furthermore, the semiconductor integrated circuit including task processing units which perform predetermined functional processes and are capable of accessing memories independently of each other, according to an aspect of the present invention includes: a semiconductor substrate; the task processing units formed on the semiconductor substrate and configured to select at least one of the memories independently of each other and issue requests for memory access to the selected memory independently of each other; and memory control units which are capable of operating independently of each other, are formed on the semiconductor substrate, correspond to the respective memories independently of each other, and are each configured to arbitrate the requests for memory access from the task processing units and connect, to the respective memories, the task processing units which have issued the arbitrated requests for memory access so that data can be transferred between the task processing units and the memories.

In this configuration, the memory control units greatly increase bus transmission capacity between the task processing units and the memories. In addition, the task processing units access to the memories via the memory control units independently of each other. In other words, the task processing units are allowed to operate in parallel. Flexibility in memory access is thereby increased.

Furthermore, in the semiconductor integrated circuit, at least one of the memories may be placed inside a chip of the semiconductor integrated circuit.

Furthermore, in the semiconductor integrated circuit, the semiconductor integrated circuit is placed in a package together with at least one of the memories.

Furthermore, in the semiconductor integrated circuit, the semiconductor integrated circuit transfers data to and from the memories which are external general-purpose memories.

In this configuration, the task processing units included in the semiconductor integrated circuit may access to the external general-purpose memories. The semiconductor integrated circuit is thus sufficiently compatible with conventional system platforms so that existing design may be efficiently used.

Furthermore, the imaging device according to an aspect of the present invention may include: an imaging unit configured to generate image data by producing an image from light from an object; memories in which the image data generated by the imaging unit is stored; task processing units configured to select at least one of the memories independently of each other, issue requests for memory access to the selected memory independently of each other, and perform a predetermined functional process independently of each other; and memory control units being capable of operating independently of each other, corresponding to the respective memories independently of each other, and each configured to arbitrate the requests for memory access from the task processing units and connect, to the respective memories, the task processing units which have issued the arbitrated requests for memory access so that data can be transferred between the task processing units and the memories, wherein each of the task processing units includes at least one of: an image processing unit configured to process a first image data generated by the imaging unit or a second image data stored in at least one of the memories; a compression-expansion processing unit configured to change a size of the first image data, the second image data, or image data processed by the image processing unit; a display processing unit configured to perform processing for causing a display unit to display the first image data, the second image data, or the image data processed by the image processing unit or the compression-expansion processing unit; and a processor unit configured to control at least one of the image processing units, the compression-expansion processing unit, and the display processing unit.

In this configuration, the image captured in the imaging is processed at high speed, and thus allowing high-speed continuous shooting at a high resolution and high-speed shooting.

The semiconductor device and the semiconductor integrated circuit according to the present invention have greatly increased bus transmission capacity for memory access and increased flexibility in memory access for multitasking, and thereby increases overall efficiency of memory access processing so that a fast application can be executed.

### FURTHER INFORMATION ABOUT TECHNICAL BACKGROUND TO THIS APPLICATION

The disclosure of Japanese Patent Application No. 2008-266164 filed on Oct. 15, 2008 including specification, drawings and claims is incorporated herein by reference in its entirety.

The disclosure of PCT application No. PCT/JP2009/001796 filed on Apr. 20, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a basic configuration of a semiconductor device according to the embodiment;

FIG. 2 is a block diagram showing a configuration of an imaging apparatus including a semiconductor device according to the embodiment;

FIG. 3A shows an example of a digital still camera including the semiconductor device according to the embodiment;

FIG. 3B shows an example of a digital camcorder including the semiconductor device according to the embodiment;

FIG. 4 is shows a flow of a signal in a task performed by the semiconductor device according to the embodiment;

FIG. 5 is a block diagram showing a variation of a configuration of the semiconductor device according to the embodiment;

FIG. 6A shows an example implementation of a semiconductor integrated circuit according to the embodiment;

FIG. 6B shows an example implementation of a semiconductor integrated circuit according to the embodiment;

FIG. 6C shows an example implementation of a semiconductor integrated circuit according to the embodiment; and

FIG. 7 is a block diagram showing a configuration of a conventional image processing apparatus.

### DESCRIPTION OF THE PREFERRED EMBODIMENT(S)

The following describes a preferable embodiment of a semiconductor device and a semiconductor integrated circuit according to the present invention in detail with reference to the drawings. For example, the semiconductor device and the semiconductor integrated circuit according to the present invention is implemented in an image recording and reproduction apparatus which records and reproduces image data obtained by shooting.

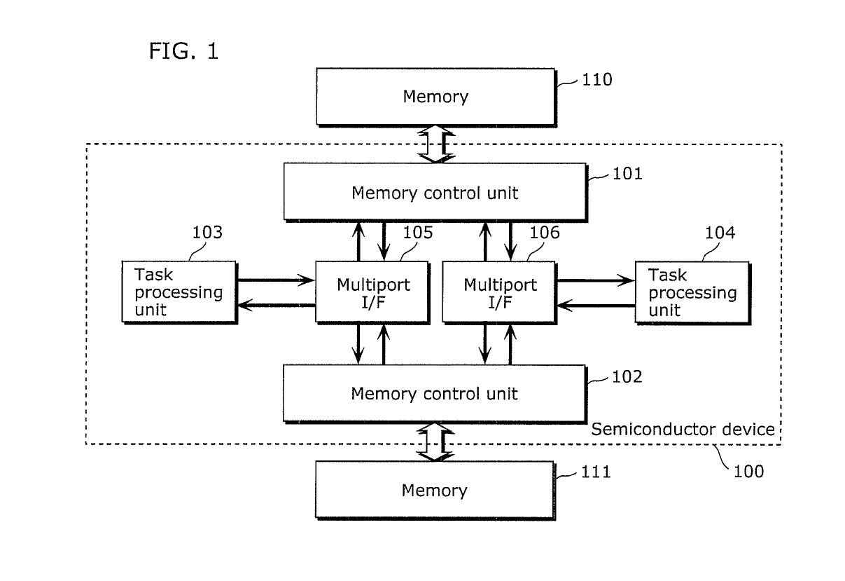

FIG. 1 is a block diagram showing a basic configuration of a semiconductor device 100 according to the embodiment. The semiconductor device 100 shown in FIG. 1 includes a memory control unit 101 and a memory control unit 102, a task processing unit 103 and a task processing unit 104, and a multiport interface 105 and a multiport interface 106, on a semiconductor substrate (not shown). The semiconductor device 100 accesses a memory 110 and a memory 111 to perform multiple functional processes while writing and reading data. At least one of the memories 110 and 111 may be formed on the semiconductor substrate.

The memory control units 101 and 102 are provided so as to respectively and correspond to the two external memories 110 and 111 independently of each other, and respectively access to the memories 110 and 111 independently of each other. For example, the memory control unit 101 arbitrates access requests from the task processing units 103 and 104, and reads data from the memory 110 or write data in the memory 110 according to the result of the arbitration of the access requests. The memory control unit 102 reads data from the memory 111 or writes data in the memory 111 in the same manner. These access processes are performed independently of each other.

The task processing units 103 and 104 each perform image processing and data processing which may be simultaneously performed. Specifically, each of the task processing units 103 and 104 selects at least one of the memories 110 and 111 independently of each other, and issues a request for memory access to the selected memory to exchange data with the selected memory. The task processing units 103 and 104 transfer data as necessary to the two memories 110 and 111 via the multiport interface 105 and 106, respectively. The cases where the task processing units 103 and 104 access each of the memories are described later using specific examples.

The multiport interfaces 105 and 106 transfer requests for access issued from the respective task processing units 103 and 104 to one of the memory control units 101 and 102, that is, the one corresponding to whether the task processing unit issues a request for access to the memory 110 or the memory 111. The multiport interfaces 105 and 106 are capable of operating independently of each other so as to independently access the two memories 110 and 111.

Each of the multiport interfaces 105 and 106 has a set of input terminal and an output terminal to connect to the respective task processing units, and further has, for the respective task processing units, a set of an input terminal and an output terminal to connect to each of the memory control units. Specifically, each of the multiport interfaces 105 and 106 has two output terminals (for the task processing units): one is for output of data to the task processing unit 103, and the other for output of data to the task processing unit 104. In addition, each of the multiport interfaces 105 and 106 has two input terminals (for the task processing units): one is for input of data from the task processing unit 103, and the other for input of data from the task processing unit 104. Furthermore, each of the multiport interfaces 105 and 106 has two output terminals (for the memory control units): one is for output of data to the memory control unit 101, and the other for output of data to the memory control unit 102. In addition, each of the multiport interfaces 105 and 106 has two input terminals (for the memory control units): one is for input of data from the memory control unit 101, and the other for input of data from the memory control unit 102.

For example, the multiport interface 105 connects the task processing unit 103 and the memory control unit 101 according to the control of the task processing unit 103. The multiport interface 105 receives data from the task processing unit 103 through the input terminal (for the task processing unit), and provides the data to the memory control unit 101 through the output terminal (for the memory control unit). The multiport interface 105 also receives data from the memory control unit 101 through the input terminal (for the memory control unit), and provides the data to the task processing unit 103 through the output terminal (for the task processing unit).

The multiport interface 105 may connect the task processing unit 103 both to the memory control units 101 and 102. The multiport interface 105 then receives data from the task processing unit 103 through the input terminal (for the task processing unit), and provides the data to both of the memory control units 101 and 102 through the two output terminals (for the memory control units). That is, the multiport interface 105 provides identical data to the memory control units 101 and 102.

In the semiconductor device 100 according to the embodiment, each of the memories is provided with a memory control unit, which allows the task processing units to access the memories independently of each other.

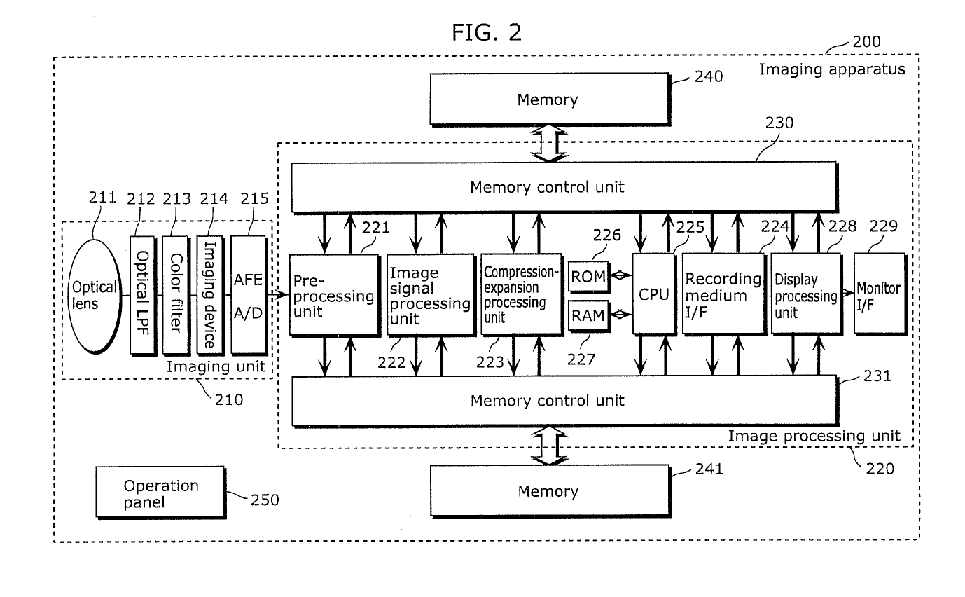

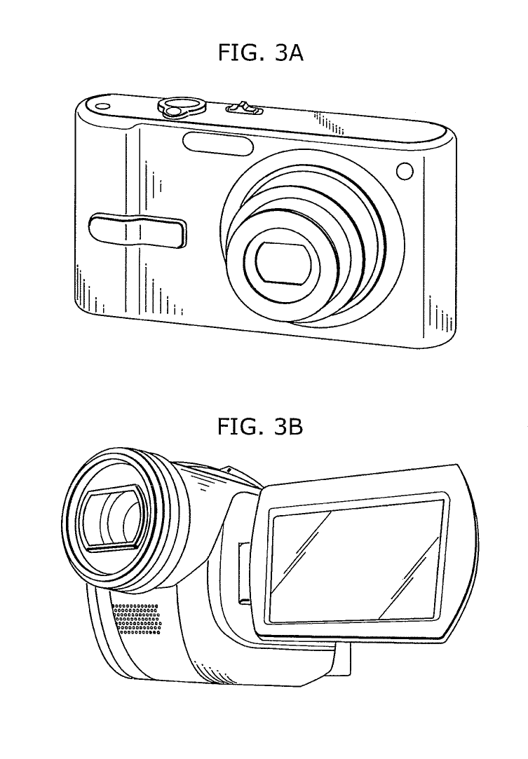

FIG. 2 is a block diagram showing a configuration of an imaging apparatus 200 including the semiconductor device according to the embodiment. The imaging apparatus 200 shown in FIG. 2 is, for example, a single-plate type digital camera (a digital still camera or a digital camcorder as shown in FIG. 3A or FIG. 3B) which converts an optical image of a captured object into digital image data and records the digital image data on a recording medium. The imaging apparatus 200 includes an imaging unit 210, an image processing unit 220, a memory 240 and a memory 241, and an operation panel 250. The image processing unit 220 is equivalent to the semiconductor device 100 shown in FIG. 1.

The imaging unit 210 includes an optical lens 211, an optical low-pass filter (LPF) 212, color filter 213, an imaging device 214, and an analog front end (AFE) unit 215.

The optical lens 211 produces, from light from an object, an image onto the imaging device 214. The light transmitted through the optical lens 211 passes through the optical LPF 212 and the color filter 213 and forms an image on a light-receiving surface of the imaging device 214.

The optical LPF 212 removes higher frequency components having frequencies equal to or higher than a sampling frequency which depends on a pixel pitch of the imaging device 214. This prevents aliasing in an image after signal processing.

The color filter 213 are filters which transmit only components at specific frequencies. For example, the color filter 213 transmits only components at frequencies corresponding to red, green or blue in each of the pixels of the imaging device 214.

The imaging device 214 is an image sensor typified by a charge coupled device (CCD) or a complementary metal oxide semiconductor (CMOS). The imaging device 214 has many photodiodes (photo-sensitive pixels) arranged two-dimensionally on the light-receiving surface, and converts light (object information) transmitted through the optical lens 211 into electric charges. Specifically, the object image produced on the light-receiving surface of the imaging device 214 is converted by the photodiodes into signal charges each of which has an amount depending on incident light volume. The signal charges are sequentially read out as voltage signals (image signals) depending on the amounts of the signal charges, on the basis of pulses provided from a driver circuit (not shown).

The imaging device 214 functions as an electronic shutter which controls a charge storage period (shutter speed) of each of the photodiodes by changing timing of shutter gate pulses. The operation of the imaging device 214 (for example, exposure and reading) is controlled by a CPU 225.

The AFE unit 215 performs processes such as adjustment of an analog gain and correlated double sampling (CDS) on the image signal output from the imaging device 214, and then analog-digital converts the image signal into a digital signal.

In the above configuration, the imaging unit 210 converts light from an object into an electric signal to generate a digital image signal. The digital image signal is provided to the image processing unit 220, and recorded on a recording medium such as a memory card (not shown) after being subjected to other necessary processes.

The imaging device 214, typified by a CMOS, may incorporate a noise processing unit, an A/D converter unit, and a parallel-serial converter unit, and directly output a digital signal for the purpose of high-speed reading.

As necessary, the image processing unit 220 performs image processing on image data provided from the imaging unit 210 and records the processed image data on a recording medium. The image processing unit 220 includes a pre-processing unit 221, an image signal processing unit 222, an compression-expansion processing unit 223, a recording medium interface 224, a CPU 225, a read-only memory (ROM) 226, a random access memory (RAM) 227, a display processing unit 228, a monitor interface 229, a memory control unit 230, and a memory control unit 231. The pre-processing unit 221, the image signal processing unit 222, the compression-expansion processing unit 223, the recording medium interface 224, the CPU 225, the display processing unit 228, and the monitor interface 229 correspond to the task processing units 103 and 104 shown in FIG. 1.

The pre-processing unit 221 is one of image processing units which processes image data provided from outside of the image processing unit 220. Specifically, the pre-processing unit 221 performs processes such as correction of black level and correction of gain on the image data (image signal) provided from the AFE unit 215. The pre-processed image data is stored in the memory 240 or 241 via the memory control unit 230 or 231. In addition, the pre-processing unit 221 includes an automatic arithmetic unit which performs calculations necessary for control of automatic exposure (AE) and auto focus (AF). When the imaging unit 210 images an object, the pre-processing unit 221 performs a calculation of a focal point evaluation value and a calculation of AE based on an image signal captured in response to halfway pressing of a release switch included in the operation panel 250.

The image signal processing unit 222 reads image data stored in the memory 240 or 241 via the memory control unit 230 or 231, and performs image processing on the read image data for a variety of purposes. For example, the image signal processing unit 222 reads image data pre-processed by the pre-processing unit 221 from the memory 240 or 241, and performs image processing on the read image data.

The image processing may be performed for purposes such as synchronization (calculation of colors of points with interpolation of color signals to compensate spatial difference in arrangement of the color filters), adjustment of white balance (WB), gamma correction, generation of a luminance signal and a color-difference signal, edge enhancement, scale change (enlargement and reduction) by electronic zoom, and change of the number of pixels (resizing). The processed image data is stored in the memory 240 or 241 via the memory control unit 230 or 231.

The compression-expansion processing unit 223 reads image data stored in the memory 240 or 241 via the memory control unit 230 or 231, and compresses the read image data in accordance with a predetermined compression format. For example, the compression-expansion processing unit 223 reads image data processed by the image signal processing unit 222 from the memory 240 or 241, and compresses or expands the read image data. The predetermined compression format may be a method such as Joint Photographic Experts Group (JPEG), Moving Picture Experts Group (MPEG), or the like. The compression-expansion processing unit 223 is a compression engine corresponding to a compression method to be used.

The recording medium interface 224 is an interface which transfers data between the recording medium (not shown) and the processing units of the image processing unit 220 (for example, the compression-expansion processing unit 223), and between the recording medium and the memories 240 and 241. The recording medium is not limited to a semiconductor memory typified by a memory card. Various types of media such as a magnetic disk, an optical disc, and a magnetic optical disc may be used as the recording medium. Not only a removable medium but also a recording medium incorporated (an internal memory) in the imaging apparatus 200 is applicable.

The CPU 225 is a control unit which has overall control over the imaging apparatus 200 by controlling operation of each of the processing units in the imaging apparatus 200 according to instruction signals from the operation panel 250. Specifically, the CPU 225 controls automatic exposure (AE), auto focus (AF), auto white balance (AWB), lens driving, image processing, reading and writing of data on the recording medium while controlling the imaging unit 210 including the imaging device 214, according to imaging conditions (for example, exposure, shooting with or without strobe light, shooting mode) and instruction signals from the operation panel 250.

The ROM 226 is a memory in which various types of data necessary for the control and a program executed by the CPU 225.

The RAM 227 is used as a working space of the CPU 225.

The display processing unit 228 performs processing for displaying image data read from the memory 240 or 241 on an image display monitor provided to the imaging apparatus 200. For example, the display processing unit 228 reads image data processed by at least one of the image signal processing unit 222 and the compression-expansion processing unit 223, and processes the read image data so as to display the image data on the image display monitor. For example, the display processing unit 228 fits the size of an image to the number of pixels of the monitor.

The monitor interface 229 is an interface which transfers data between the display processing unit 228 and the monitor so that the image processed by the display processing unit 228 is displayed on the image display monitor of the imaging apparatus 200. The image display monitor may be an external display.

The memory control units 230 and 231 arbitrate memory access requests from the processing units included in the image processing unit 220 so as to allow each of the processing units which has issued the arbitrated access request to transfer data to and from the memories. The memory control units 230 and 231 respectively correspond to the memories 240 and 241 and transfer data to and from the memories 240 and 241. The memory control units 230 and 231 correspond to the memory control units 101 and 102 shown in FIG. 1, respectively.

The memories 240 and 241 store image data generated by the imaging unit 210. The memories 240 and 241 also store image data subjected to a variety of processes performed by the image processing unit 220. The memories 240 and 241 correspond to the memories 110 and 111 shown in FIG. 1, respectively.

The operation panel 250 is a unit through which a user input instructions to the imaging apparatus 200. For example, the operation panel 250 includes switches such as a mode selection switch for selection of operation modes of the imaging apparatus 200, a direction pad for selection of menu items (cursor move) and frame-by-frame forward and backward playback, an execute key for confirmation (registration) of a selected item and an instruction of execution of an operation, a cancel key for deletion of a desired object such as a selected item and cancelation of an instruction, a power switch, a zoom switch, a release switch, and a touch panel.

The multiport interfaces 105 and 106 shown in FIG. 1 respectively connect the memory control units 230 and 231 to the equivalent of the task processing units 103 and 104 shown in FIG. 1, that is, the pre-processing unit 221, the image signal processing unit 222, the compression-expansion processing unit 223, the recording medium interface 224, the CPU 225, and the display processing unit 228.

The following describes processing performed by the imaging apparatus 200 according to the embodiment, from imaging to the recording of the image data obtained by the imaging on a recording medium.

First, the CPU 225 controls auto focus (AF) when detecting the release switch being pressed halfway, and then starts control of exposure and reading for capture of an image to be recorded when detecting the release switch being pressed all the way. In addition, the CPU 225 issues a command to a strobe light control circuit (not shown) as necessary in order to control flashing of a flash light tube (light emitting unit) such as a xenon tube.

When the CPU 225 detects the release switch being pressed halfway, the automatic arithmetic unit included in the pre-processing unit 221 performs a calculation of a focal point evaluation value and a calculation of AE based on the image signal captured in response to the halfway pressing of the release switch, and the CPU 225 receives the result of the calculations. When detecting the release switch being pressed all the way, the CPU 225 controls a lens-driving motor (not shown) on the basis of the result of the calculation of a focal point evaluation value, moves the optical lens 211 to focus on the object, and controls exposure by controlling aperture and the electronic shutter. The electric signal generated by the imaging device 214 is converted into a digital signal by the AFE unit 215 and provided to the image processing unit 220 as an image signal.

The image processing unit 220 records image data provided from the imaging unit 210 on a recording medium through the recording medium interface 224 in a recording mode. The image data may be recorded in an image recording mode for a JPEG format, for an MPEG format, or a RAW format in which the image data is recorded immediately after analog-to-digital conversion without compression. Hereinafter, an image recorded in a RAW format mode is referred to as a CCD RAW image, and image data immediately after analog-to-digital conversion by the AFE unit 215 is referred to as RAW data.

When an image data is recorded in JPEG format, the pre-processing unit 221 pre-processes RAW data and stores the pre-processed image data in the memory 240 or 241 via the memory control unit 230 or 231. The following describes a case where pre-processed image data is stored in the memory 240 through the memory control unit 230.

The image signal processing unit 222 reads image data stored in the memory 240 via the memory control unit 230, and performs image processing on the read image data. The processed image data is stored in the memory 241 via the memory control unit 231. In this manner, the pre-processing unit 221 and the image signal processing unit 222 may perform processing in parallel because they access different memories via different memory control units.

Next, the compression-expansion processing unit 223 reads the image data from the memory 241 via the memory control unit 231, and compresses the read image data according to JPEG compression format. The compressed image data is recorded on a recording medium through the recording medium interface 224.

On the other hand, in the RAW format mode, the RAW data is recorded on a recording medium via the memory control unit 230 or 231 and the recording medium interface 224 without being subjected to signal processing by the image signal processing unit 222 or the compression-expansion processing unit 223. That is, a CCD RAW image is an image without being processed for purposes such as gamma correction, white balance adjustment, or synchronization, and a mosaic image in which each pixel has information of one color corresponding to an array pattern of the color filters 213. Such CCD RAW image is large in size because it is not compressed at all. The CCD RAW image may be recorded on a recording medium with lossless compression or without compression.

As described above, the imaging apparatus 200 according to the embodiment has the memory control units 230 and 231 corresponding to the two memories 240 and 241, respectively. In this configuration, absolute bus transmission capacity between the memories and the memory control units is greatly increased. In addition, providing the memory control units to the memories in a corresponding manner allows flexible setting for the processing units as to a memory to access independently of each other, thereby increasing flexibility in memory access.

The following describes a method of performing high-speed continuous shooting at a high resolution, which is one of high-speed applications, using the imaging apparatus 200 configured as described above.

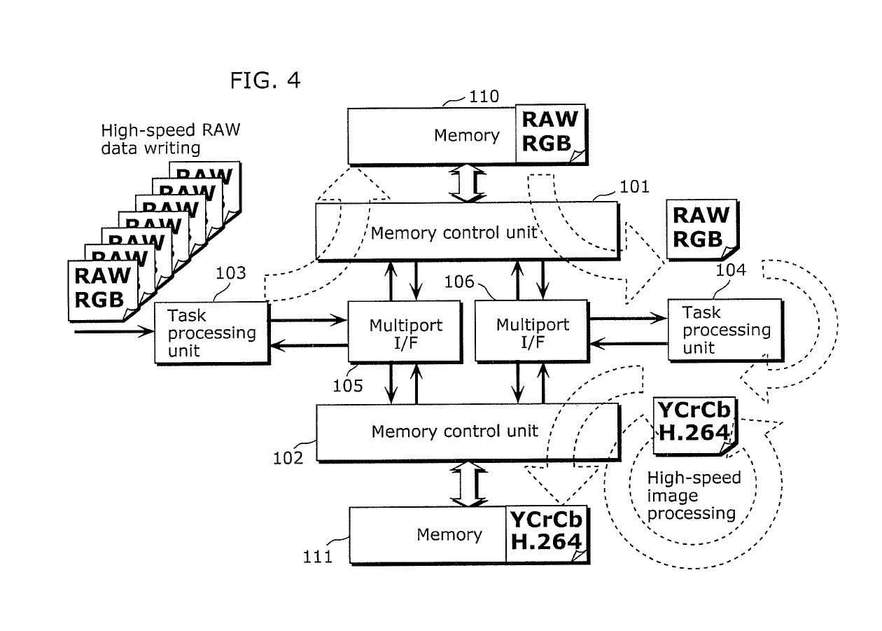

FIG. 4 shows a flow of a signal in a task performed by an semiconductor device 100 according to the embodiment. A task processing unit 103 in FIG. 4 corresponds to the pre-processing unit 221 in FIG. 2. A task processing unit 104 in FIG. 4 corresponds to the image signal processing unit 222 and the compression-expansion processing unit 223 in FIG. 2. The task processes performed by these task processing units account for a large proportion of bus transmission capacity for memory access, therefore streamlining the flow of the task processes facilitates high-speed continuous shooting. The following describes a case where image data generated in high-speed continuous shooting of the imaging unit 210 is recorded in JPEG format.

RAW data is pre-processed by the pre-processing unit 221 corresponding to the task processing unit 103. The task processing unit 103 continuously writes image data of continuously shot images in the memory 110 through the multiport interface 105 connected to the memory control unit 101.

In parallel with the writing, the image signal processing unit 222 corresponding to the task processing unit 104 reads image data from the memory 110 through the multiport interface 106 according to the result of arbitration by the memory control unit 101. Next, the task processing unit 104 performs a variety of processes such as synchronization, WB adjustment, gamma correction, generation of a luminance signal and a color-difference signal, edge enhancement, scale change by electronic zoom, and change of the number of pixels. Next, the task processing unit 104 writes processed image data in the memory 111 through the multiport interface 106 connected to the other one of the memory control units, that is, the memory control unit 102.

Next, the compression-expansion processing unit 223 corresponding to the task processing unit 104 reads the processed image data from the memory 111 through the multiport interface 106 connected to the memory control unit 102. Next, the task processing unit 104 compresses the image data in JPEG format and writes the image data compressed in JPEG format in the memory 111 through the multiport interface 106.

In this manner, increased bus transmission capacity is efficiently used by causing high-load processes, that is, tasks which use a large proportion of the bus transmission capacity for memory access to access different memories via different memory control units.

In the description above, the multiport interface 105 connects an input terminal for input from the task processing unit 103 to an output terminal for output to the memory control unit 101. The multiport interface 106 connects an input terminal for input from the memory control unit 101 to an output terminal for output to the task processing unit 104, an input terminal for input from the task processing unit 104 to an output terminal for output to the memory control unit 102, and an input terminal for input from the memory control unit 102 to an output terminal for output to the task processing unit 104. Connection to be used is controlled by, for example, the CPU 225.

As in the above case of a signal flow through which continuous shooting in JPEG format is performed, video shooting at a high frame rate is performed in the same manner, using the two memory control units 101 and 102 to distribute bus traffic of the data.

More task processing units which correspond to the recording medium interface 224, the CPU 225, or the display processing unit 228 in FIG. 2 may be added in the flow system. That is, the added task processing units and the memory control units 101 and 102 are connected such that an image signal is processed in parallel by distributing bus traffic of data using the two memory control units 101 and 102.

The following describes a process of controlling data transfer between task processing units and memories when multiple task processing units included in the semiconductor device 100 according to the embodiment simultaneously performs multiple time-sensitive processes as shown in FIG. 4.

For example, a memory from which data is read (source) and a memory in which data is written (destination) may be selected for the task processing units 103 and 104 depending on the type of the process to be performed by each of the task processing units 103 and 104. Selection of a memory for the task processing units 103 and 104 is made by, for example, the CPU 225. In the example shown in FIG. 4, the pre-processed image data is stored in the memory 110 and the image data subjected to the image signal processing is stored in the memory 111 under control of the CPU 225.

In this configuration, traffic of memory access may be separated and distributed. The task processing unit 103 and 104 may each have a memory predetermined as a source or a destination of data transfer.

Alternatively, memory to be a source or a destination of data transfer may be determined depending on the statuses of memory access from the memory control units. Specifically, the task processing units 103 and 104 monitor statuses of memory access from the memory control units 101 and 102. A memory control unit which has an idle rate of memory access larger than a predetermined threshold is selected for each of the task processing units 103 and 104. The task processing units 103 and 104 transfer data to and from the memory corresponding to the selected memory control unit, so that traffic of memory access may be separated and distributed.

Here, a memory control unit is selected from the two memory control units 101 and 102 for each of the task processing units 103 and 104. For example, the one which has a larger idle rate of memory access is selected from the two memory control units 101 and 102. In the case where the semiconductor device 100 includes three or more memory control units, a memory control unit having the largest idle rate of memory access may be selected for the task processing units 103 and 104.

For example, in the case shown in FIG. 4, when the task processing unit 103 writes image data in the memory 110 via the memory control unit 101, the task processing unit 104 reads image data from the memory 110 via the memory control unit 101. This process reduces an idle rate of memory access to the memory 110. The task processing unit 104 therefore writes the processed image data in the memory 111 via the memory control unit 102 so that the traffic of memory access is distributed.

Alternatively, only one of the memory control units may be used when the memory access process is smaller than a predetermined threshold. Specifically, in the case where memory access process is small when, for example, the number of pixels of the sensor included in the imaging device 214 is smaller than a predetermined threshold, or when the frame rate of a video is lower than a predetermined threshold, the task processing units 103 and 104 select only one of the memory control units (for example, the memory control unit 101), and transfer data to and from a memory corresponding to the selected memory control unit (for example, the memory 110). In this case, the selected memory control unit 101 arbitrates requests for memory access from the task processing units 103 and 104, and connects the memory 110 with the task processing units via the multiport interface 105 and 106 so that data is transferred between the memory 110 and the task processing units according to the result of the arbitration.

In this configuration, only one of the memory control units is used and the other one (for example, the memory control unit 102) may be placed into sleep mode, and power consumption is thereby reduced.

When the memory access process is greater than a predetermined threshold, one of the task processing units may use two or more memory control units. For example, the task processing unit 103 transfers data to the memory 111 via the memory control unit 102 as well as to the memory 110 via the memory control unit 101. Traffic of memory access is thus distributed.

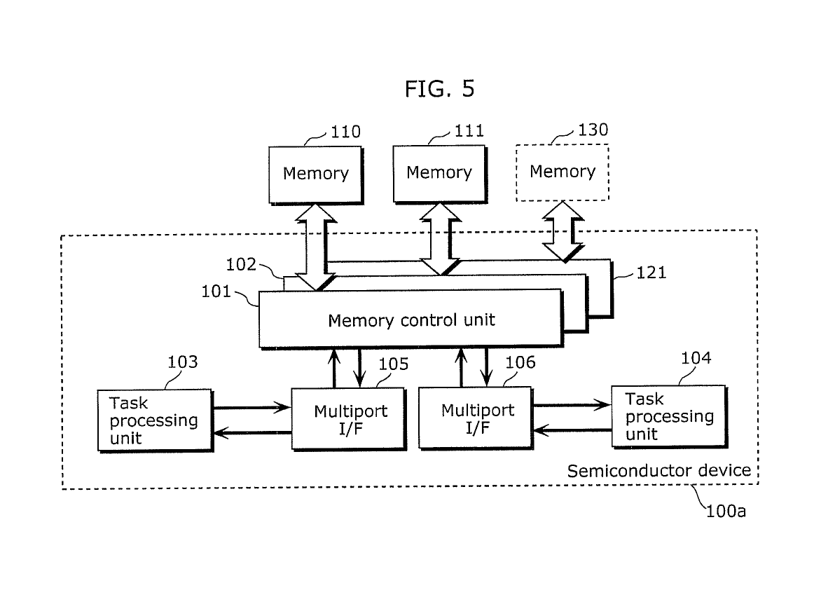

In addition, the system may be extended with an additional memory as shown in FIG. 5. FIG. 5 is a block diagram showing a variation of a configuration of the semiconductor device according to the embodiment. The semiconductor device 100a shown in FIG. 5 is different from the semiconductor device 100 shown in FIG. 1 in that the semiconductor device 100a additionally includes a memory control unit 121.

The memory control unit 121 corresponds to an additional memory 130, and transfers data between the memory 130 and the task processing units 103 and 104.

In the configuration where the semiconductor device 100a includes the memory control unit 121, the semiconductor device 100a may transfer data to and from the additional memory 130 in the same manner as the memories 110 and 111. In other words, the semiconductor device 100a may include one or more sockets to connect additional memories, and memory control units as many as the sockets.

Alternatively, a task processing unit which performs a task of high priority may exclusively use one of the memory control units. For example, when a task to be performed by the task processing unit 103 is prior to a task to be performed by the task processing unit 104, the task processing unit 103 may exclusively use the memory control unit 101. In this configuration, it is not necessary for the memory control unit 101 to arbitrate interruptive requests for memory access from the task processing unit 104, so that memory control unit 101 may transfer data to and from the task processing unit 103 at a high speed.

This configuration produces an advantageous effect particularly for a system provided with a plurality of CPUs for use in, for example, network protocol processing or software graphic processing.

The following describes example implementations of the semiconductor device 100 according to the embodiment.

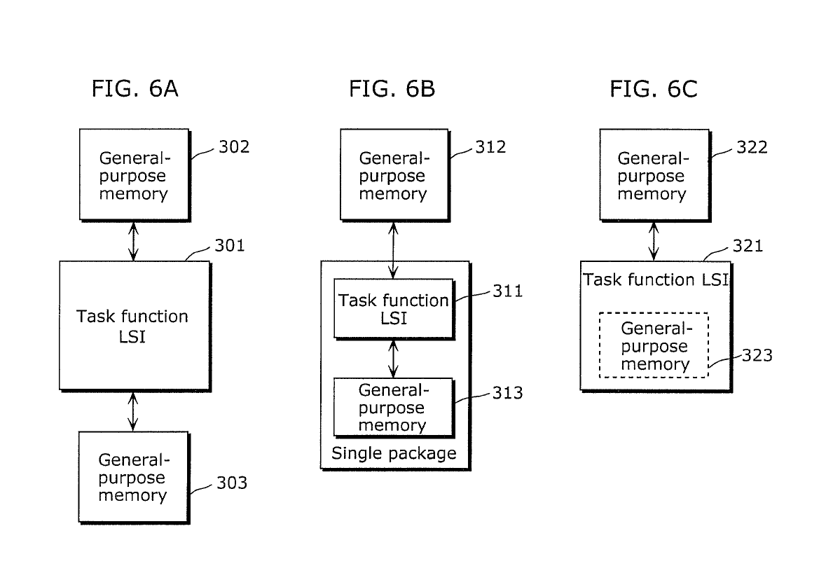

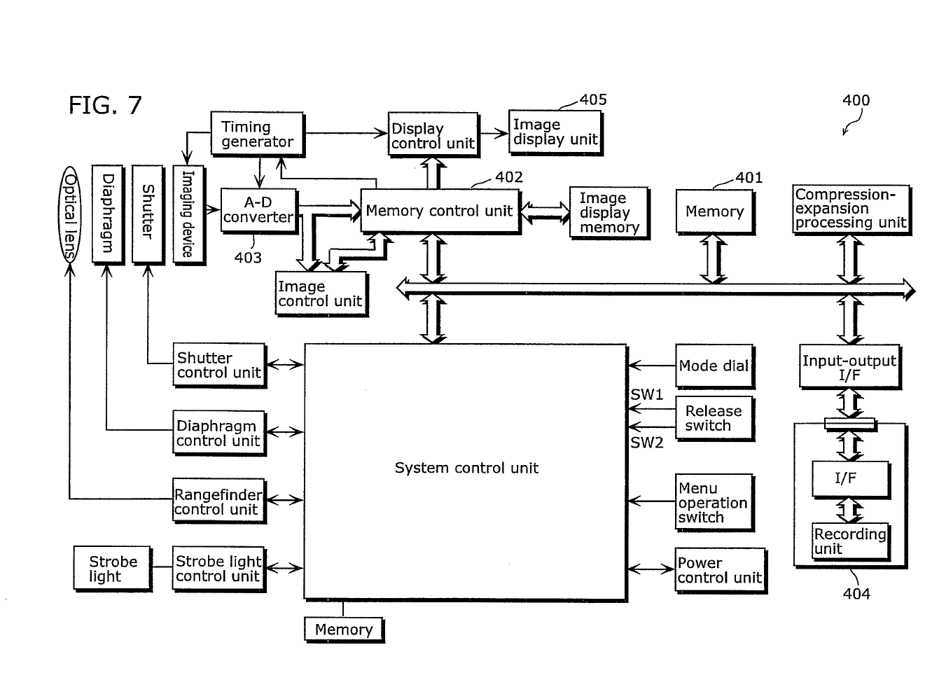

FIG. 6A to FIG. 6C show example implementations in which each of the processing units of the imaging apparatus 200 according to the embodiment is implemented as a semiconductor integrated circuit on a semiconductor substrate. In the example implementation shown in FIG. 6A, a task function LSI 301, which corresponds to the semiconductor device 100 shown in FIG. 1, is connected to external general-purpose memories 302 and 303.

In the example implementation shown in FIG. 6B, a task function LSI 311 and a general-purpose memories 313 are placed together in a single package. The task function LSI 311 is connected to the general-purpose memory 313 in the package and an external general-purpose memory 312.

In the example implementation shown in FIG. 6C, a general-purpose memory 323 is included in a chip of a task function LSI 321 includes. The task function LSI 321 is connected to the general-purpose memory 323 in the chip and an external general-purpose memory 322. The semiconductor device according to the embodiment, that is, the task function LSI may be implemented as a combination of the example implementations, and may be connected to another memory. The method of implementation of the task function LSI is not limited.

As described above, the semiconductor device and the semiconductor integrated circuit according to the embodiment enables parallel operation of task processing units by using memory control units which are capable of accessing the memories independently of each other. In this configuration, bus transmission capacity for memory access between the task processing units and the memories is greatly increased. In addition, the task processing units are capable of accessing the memories independently of each other, flexibility in memory access is thereby increased. Overall efficiency of memory access processing is thus increased.

Although only an exemplary embodiment of the semiconductor device and the semiconductor integrated circuit according to the present invention has been described in detail above, those skilled in the art will readily appreciate that many modifications are possible in the exemplary embodiment without materially departing from the novel teachings and advantages of the present invention. Accordingly, all such modifications are intended to be included within the scope of the present invention.

For example, although FIG. 6A to FIG. 6C show configurations in which one of the memories is an external general-purpose memory, all of the memories may be included in a chip. All of the general-purpose memories may be placed together in a single package.

### INDUSTRIAL APPLICABILITY

As described above, the semiconductor device and the semiconductor integrated circuit according to the present invention are applicable to an imaging apparatus which captures an image, and records and reproduces the image. For example, the semiconductor device and the semiconductor integrated circuit are applicable to a digital camera which performs high-speed operations such as high-speed continuous shooting at a high resolution or a high-speed shooting.

What is claimed is:

1. A semiconductor device including task processing units which perform predetermined functional processes and are capable of accessing memories independently of each other, said semiconductor device comprising:
a semiconductor substrate;
said task processing units formed on said semiconductor substrate and configured to select at least one of the memories independently of each other and issue requests for memory access to the selected memory independently of each other; and
memory control units which are capable of operating independently of each other, are formed on said semiconductor substrate, correspond to the respective memories independently of each other, and are each configured to arbitrate the requests for memory access from said task processing units and connect, to the respective memories, said task processing units which have issued the arbitrated requests for memory access so that data can be transferred between said task processing units and the memories.

2. The semiconductor device according to claim 1,
wherein each of said task processing units includes at least one of:
an image processing unit configured to process a first image data externally input or a second image data stored in at least one of the memories;
a compression-expansion processing unit configured to change a size of the first image data, the second image data, or image data processed by said image processing unit;
a display processing unit configured to perform processing for causing a display unit to display the first image data, the second image data, or the image data processed by said image processing unit or said compression-expansion processing unit; and
a processor unit configured to control at least one of said image processing units, said compression-expansion processing unit, and said display processing unit.

3. The semiconductor device according to claim 1, further comprising
a multiport interface unit which is formed on said semiconductor substrate and configured to selectively connect each of said task processing units and each of said memory control units.

4. The semiconductor device according to claim 3,
wherein said multiport interface unit has an output terminal for each of said task processing units, an input terminal for each of said task processing units, an output terminal for each of said memory control units, and an input terminal for each of said memory control units.

5. The semiconductor device according to claim 3,
wherein, when said multiport interface unit connects one of said task processing units and one of said memory control units, said multiport interface unit is configured to transfer input data received from said connected task processing unit to said connected memory control unit.

6. The semiconductor device according to claim 3,
wherein, when said multiport interface unit connects one of said task processing units and two or more of said memory control units, said multiport interface unit is configured to transfer input data received from said connected task processing unit to said connected two or more memory control units in parallel.

7. The semiconductor device according to claim 3,
wherein, when said multiport interface unit connects one of said memory control units and one of said task processing units, said multiport interface unit is configured to transfer input data received from said connected memory control unit to said connected task processing unit.

8. The semiconductor device according to claim 1,
wherein, when said task processing units simultaneously process time-sensitive processes, said task processing units are configured to transfer data, via a memory control unit predetermined for each of said task processing units, to and from the memory corresponding to said memory control unit.

9. The semiconductor device according to claim 1,
wherein, when said task processing units simultaneously process time-sensitive processes, said task processing units are configured to select a source memory and a destination memory for data of each of the processes from among the memories, depending on a type of the process to be performed by each of said task processing units.

10. The semiconductor device according to claim 1,
wherein, when said task processing units simultaneously process time-sensitive processes, each of said task processing units is configured to monitor a status of memory access from said memory control units, select, from among said memory control units, a memory control unit having an idle rate of memory access larger than a predetermined threshold, and transfer data, via said selected memory control unit, to and from the memory corresponding to said selected memory control unit.

11. The semiconductor device according to claim 1,
wherein, when said task processing units simultaneously process time-sensitive processes and memory access processing is smaller than a predetermined threshold, said task processing units are configured to select a common one of said memory control units and transfer data, via said selected memory control unit, to and from the memory corresponding to said selected memory control unit, and
place, into sleep mode, said memory control unit other than said memory control unit selected by said task processing units.

12. The semiconductor device according to claim 1,
wherein, when said task processing units simultaneously process time-sensitive processes, said task processing units are configured to transfer data, via one of said memory control units, to and from the memory corresponding to said memory control unit, and transfer data, via an other one of said memory control units, to and from the memory corresponding to said other one.

13. The semiconductor device according to claim 1,
wherein, when a task to be performed by one of said task processing units is prior to a task to be performed by an other one of said task processing units, said one of said task processing units is configured to exclusively use one of said memory control units and transfer data, via said exclusively used memory control unit, to and from the memory corresponding to said exclusively used memory control unit.

14. A semiconductor integrated circuit including task processing units which perform predetermined functional processes and are capable of accessing memories independently of each other, said semiconductor device comprising:
a semiconductor substrate;
said task processing units formed on said semiconductor substrate and configured to select at least one of the memories independently of each other and issue requests for memory access to the selected memory independently of each other; and
memory control units which are capable of operating independently of each other, are formed on said semiconductor substrate, correspond to the respective memories independently of each other, and are each configured to arbitrate the requests for memory access from said task processing units and connect, to the respective memories, said task processing units which have issued the arbitrated requests for memory access so that data can be transferred between said task processing units and the memories.

15. The semiconductor integrated circuit according to claim 14,
wherein at least one of said memories is placed inside a chip of said semiconductor integrated circuit.

16. The semiconductor integrated circuit according to claim 14,
wherein said semiconductor integrated circuit is placed in a package together with at least one of said memories.

17. The semiconductor integrated circuit according to claim 14,
wherein said semiconductor integrated circuit transfers data to and from said memories which are external general-purpose memories.

18. An imaging apparatus comprising:
an imaging unit configured to generate image data by producing an image from light from an object;
memories in which the image data generated by said imaging unit is stored;
task processing units configured to select at least one of said memories independently of each other, issue requests for memory access to said selected memory independently of each other, and perform a predetermined functional process independently of each other; and
memory control units being capable of operating independently of each other, corresponding to said respective memories independently of each other, and each configured to arbitrate the requests for memory access from said task processing units and connect, to said respective memories, said task processing units which have issued the arbitrated requests for memory access so that data can be transferred between said task processing units and said memories,
wherein each of said task processing units includes at least one of:
an image processing unit configured to process a first image data generated by said imaging unit or a second image data stored in at least one of said memories;
a compression-expansion processing unit configured to change a size of the first image data, the second image data, or image data processed by said image processing unit;
a display processing unit configured to perform processing for causing a display unit to display the first image data, the second image data, or the image data processed by said image processing unit or said compression-expansion processing unit; and
a processor unit configured to control at least one of said image processing units, said compression-expansion processing unit, and said display processing unit.
